(19) United States
(12) Patent Application Publication
(10) Pub. No.: US 2005/0214527 A1
(43) Pub. Date: Sep. 29, 2005

(54) Method for coating potable water tanks and coated structures for contact with potable water

(75) Inventor: Thomas Dudick, Hudson, OH (US)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(73) Assignee: Dudick, Inc.

(21) Appl. No.: 11/089,322

(22) Filed: Mar. 24, 2005

Related U.S. Application Data
(60) Provisional application No. 60/557,289, filed on Mar. 29, 2004.

(51) Int. Cl. B32B 5/16; B05D 1/12

(52) U.S. Cl. 428/331; 427/181; 427/180

(57) ABSTRACT

A method of coating potable water structures comprises applying a first resin to the interior surfaces of the structure and curing the resin to provide a primer layer; applying a second resin, containing a conductive filler, to the primer layer and curing the resin to provide a conductive layer; applying a first silica-reinforced resin to the conductive layer to provide an uncured basecoat precursor layer; applying a reinforcing fabric to the uncured basecoat precursor layer; applying a second silica-reinforced resin, which may be the same as or different from the first silica-reinforced resin, to the reinforcing fabric and curing the first and second silica-reinforced polymer resins to provide a basecoat layer; and applying a polymer suitable for contact with potable water to the basecoat layer and curing the polymer to provide a topcoat layer; wherein the method results in a coated surface that is suitable for contact with potable water and further wherein the coated surface is stable for a period of at least ten months after coating according to the method. A coated structure suitable for contact with potable water comprises a primer layer in contact with the interior surfaces of the structure; a conductive layer in contact with the primer layer; a silica-reinforced polymer resin basecoat layer in contact with the conductive layer, wherein the basecoat layer contains a reinforcing fabric; and a polymer topcoat layer in contact with the basecoat layer, wherein the polymer topcoat layer is suitable for contact with potable water.

### CROSS-REFERENCE TO RELATED APPLICATIONS

This application claims priority from provisional application U.S. Ser. No. 60/557,289, filed on Mar. 29, 2004.

### BACKGROUND OF THE INVENTION

This invention relates to the repair and reconditioning of substrates suitable for containing potable water. More particularly, this invention relates to a method of surface treating a substrate. Specifically, this invention relates to a method of coating water tanks used in potable water treatment systems.

Because of its economical nature, concrete is widely used in buildings, roads, tunnels, canals, tanks and other structures. However, concrete structures are also subject to attack by water over time. Degradation of concrete structures is typically caused by a dissolving of the bonding ingredients of the concrete. This can eventually result in cracks in the concrete structure. Spalling, that is, where the surface of the concrete lifts from the remainder of the structure, can also occur. If the damage becomes extensive, crumbling of the structure can occur.

Municipalities utilize concrete holding tanks in their potable water treatment systems. For example, the city of Chicago obtains its water from Lake Michigan through concrete water intake structures located about two miles from the shoreline. These structures are at least several decades old and show signs of deterioration, including cracking and spalling. The economical nature of concrete notwithstanding, it is desirable to repair such structures instead of replacing them, especially in light of their location. Such repairs to the concrete must be compatible with their use as a source of potable water.

To repair concrete structures that have degraded over time, a number of approaches are known. For example, U.S. Pat. No. 4,758,295 discloses a method for repairing a concrete structure which includes forming a sealed chamber in a leaking part of the concrete structure and injecting a polyurethane prepolymer into the chamber, thereby sealing connecting cracks in the concrete structure with the polymerization of the prepolymer. However, the formation of a sealed chamber according to the '295 patent includes boring the structure in the center of a crack. This can be a time consuming, laborious process especially where a structure has a plurality of areas to be repaired. The '295 patent does not disclose the surface treatment of a concrete structure.

Another method of treating a concrete substrate is disclosed in U.S. Pat. No. 4,559,239. This method includes the use of a polyurethane precursor sprayed on the surface of the substrate and polymerized in place. While this method may be used to seal concrete structures such as irrigation canals and the like, the patent does not provide that the coating is pinhole free, or that the coating in contact with water is suitable for potable water systems.

Therefore, a need exists for a method of coating a concrete structure in a potable water system that insures that the coating is pinhole free. A need also exists for a method of coating a concrete structure that is capable of filling voids in the concrete.

### BRIEF SUMMARY OF THE INVENTION

It is, therefore, an aspect of the present invention to provide a method of coating a structure that provides a coating that is acceptable for use with potable water.

It is another aspect of the present invention to provide a method of coating a structure that is pinhole free.

It is still another aspect of the present invention to provide a method of coating a structure that is capable of filling voids and bridging cracks in the structure.

It is yet another aspect of the present invention to provide a method of coating a concrete structure that may be utilized on either dry or damp concrete.

At least one or more of the foregoing aspects, together with the advantages thereof over the known art relating to concrete coatings, which shall become apparent from the specification which follows, are accomplished by the invention as herein after described and claimed.

In general, the present invention provides a method of coating potable water structures comprising applying a first resin to the interior surfaces of the structure and curing the resin to provide a primer layer; applying a second resin, containing a conductive filler, to the primer layer and curing the resin to provide a conductive layer; applying a first silica-reinforced resin to the conductive layer to provide an uncured basecoat precursor layer; applying a reinforcing fabric to the uncured basecoat precursor layer; applying a second silica-reinforced resin, which may be the same as or different from the first silica-reinforced resin, to the reinforcing fabric and curing the first and second silica-reinforced polymer resins to provide a basecoat layer; and applying a polymer suitable for contact with potable water to the basecoat layer and curing the polymer to provide a topcoat layer; wherein the method results in a coated surface that is suitable for contact with potable water and further wherein the coated surface is stable for a period of at least ten months after coating according to the method.

The present invention further provides a coated structure suitable for contact with potable water comprising a primer layer in contact with the interior surfaces of the structure; a conductive layer in contact with the primer layer; a silica-reinforced polymer resin basecoat layer in contact with the conductive layer, wherein the basecoat layer contains a reinforcing fabric; and a polymer topcoat layer in contact with the basecoat layer, wherein the polymer topcoat layer is suitable for contact with potable water.

### DETAILED DESCRIPTION OF THE INVENTION

The present invention is directed toward a method of coating a potable water tank. The method results in a coating that is stable and does not degrade over time. In certain embodiments, the coating is stable for at least 10 months, and in one or more embodiments, the coating is stable for one, three, five, ten or even twenty years or more.

Water tanks are made out of a variety of materials. Cementitious materials are conventionally employed and these include all forms and types of concretes, as can be cast and cured in the form of a container having a desired shape and volume. Fiber reinforced resins, or FRP's, composites of thermoplastic resins reinforced by fibers, typically fiberglass, can also be employed to manufacture water tanks. Throughout the specification, reference to structures, surfaces or water tanks is intended to include all cementitious materials and FRP's suitable for contact with potable water. Likewise, contact with potable water is inclusive of vessels for carrying potable water as well as containing, conveying, holding, storage and the like.

The method of the present invention includes the application of a primer coat to the structure, namely the interior surfaces of the structure e.g., tank, which will have contact with potable water. The primer acts to penetrate the surface of the vessel and reinforce its surface tensile strength. The method of application is not particularly limited. Typically, the primer coat is applied by brush, roller, spray, or other method. In one embodiment, the primer coat is characterized by a Dry Film Thickness (DFT) of from about 1 to about 4 mils.

Examples of primers include epoxy resins such as low viscosity bisphenol A, bisphenol F resins and/or bisphenol A blends with C₁₂-C₁₄ alkyl glycidyl ethers, neopentyl digylcidyl ether, cresyl glycidyl ether, 2-ethylhexyl glycidyl ether, and cyclohexane-dimethanol diglycidyl ether. Other examples of epoxy resins include vinyl esters and polyesters such as epoxy novolac vinyl ester, bisphenol A-fumarate based polyesters, and blends of the foregoing epoxy resins. The polymerization of these epoxy resins may be accomplished with catalysts such as amine hardeners, including but not limited to polyamides, amido-amines, modified cycloaliphatics based on isophorone diamine (IPDA), meta-xylene diamine (MXDA), 1,3-Bis(aminomethyl) cyclohexane (1,3 BAC), methylene dicyclohexyl-amine (PACM), mannich base curing agents, aliphatic amines and their epoxy adducts. In one embodiment, a blend of polyamide and mannich base curatives is employed to provide for moisture tolerance during the cure. Bisphenol A resins may be used for applications where the concrete structure is damp, because of their moisture tolerance.

After the primer coat is cured, a conductive layer is applied over the primer coat. The conductive layer comprises a polymer resin and one or more conductive fillers. The polymer resin may include an epoxy resin as described above. The conductive filler may include graphite, conductive carbon black, carbon fiber, coke, and the like.

The polymerization of these conductive epoxy resins may also be accomplished with catalysts such as amine hardeners for bisphenol A resins, or other hardeners as described above. The epoxy resin and conductive filler form a conductive layer in which the electrical resistance is less than about 50,000 ohms when tested at 500 v dc. The conductive layer allows the completed lining system to be spark tested to insure that the completed system is pinhole free.

A basecoat layer is then applied to the conductive layer after the conductive layer has cured for a suitable period of time, depending on temperature and humidity. The basecoat layer includes a polymer resin and a silica reinforcement. The polymer resin may include a bisphenol A resin or resin blend, bisphenol F resin, vinyl ester resin, or polyester resin, as described above. The silica reinforcement is typically present at in an amount of approximately 0.5 pounds silica per square foot of surface area of concrete substrate, although the amount is not particularly limited.

Optionally, the basecoat may further include a flexibilizing agent. In one embodiment, the basecoat is preferably a silica reinforced, flexibilized epoxy resin with amine curative, formulated such that the unreinforced resin system exhibits a minimum tensile elongation of about 100% per ASTM D412. Flexibilizing agents include, but are not limited to, epoxidized cashew nut oil (Cardolite NC-513), acrylate functional urethanes (Ancarez 2364), liquid polysulfide resins (Toray LP-3) and/or amine hardeners including, but not limited to, polyamides, amido-amines, modified cycloaliphatics based on IPDA, MXDA, 1,3 BAC, PACM, mannich base curing agents, aliphatic amines and their epoxy adducts. In one embodiment, a blend of polyamide and mannich base curatives are employed to provide for moisture tolerance during the cure.

Initially, basecoat resin may be applied to form a basecoat precursor layer. The amount of basecoat resin applied to form the precursor layer is not particularly limited. A thickness of about 1/16 inch is frequently sufficient. In certain embodiments, the basecoat resin is applied at a thickness of about 1/32 inch to about 1/4 inch as needed to fill void and bridge cracks in the concrete. The uncured basecoat resin typically has a mortar-like consistency and is applied with a trowel or other suitable tool for a material of such a consistency.

A reinforcing fabric is then applied to the uncured basecoat precursor layer. The reinforcing fabric may include a fiberglass mat or other reinforcing material. In one embodiment, the reinforcing fabric is first saturated with the uncured basecoat resin or a compatible basecoat resin mixture, and then applied to the uncured basecoat precursor layer. Edges of the mat are typically overlapped by approximately one inch. The weight of the fiberglass mat is not particularly limited, and may be range from chopped strand fiberglass mats of about ¾ oz to 1½ oz weights to fabrics of fiberglass or synthetics up to about 24 oz weights. In certain embodiments, the fiberglass mat allows the lining system to withstand surface cracks and movement of up to about 50 mils without loss of integrity.

The reinforcing fabric is then coated with another layer of basecoat resin, typically at a thickness of from about 8 to about 10 mils. The second basecoat layer can be the same as or different from the first basecoat but otherwise comprises a basecoat polymer resin and optional flexibilizing agent, as described hereinabove. Any visible air bubbles trapped under the fiberglass mat or visible wrinkles in the mat can be removed, for example, by rolling with a ribbed roller. The basecoat resin, including the basecoat precursor layer, the additional basecoat layer, and containing the reinforcing fabric, is then allowed to cure, typically overnight. The polymerization of the basecoat resin may be catalyzed with an amine hardener such as those described hereinabove.

Optionally, the cured basecoat layer is then inspected for any imperfections such as air bubbles or blisters. If such imperfections are found, they are removed and repaired, repeating the previous step for that section. Additionally, it is generally desirable to lightly sand the surface of the cured basecoat layer, especially along overlapped seams of the reinforcing fabric, to present a smooth surface prior to applying a topcoat layer.

If desired, before a topcoat layer is applied, the existing layers are tested to insure that the system is pinhole free. A preferred testing method is spark testing. Spark testing, or “holiday testing”, involves the passing of high voltage dc current over the lining system through a wand. Linings of this type are tested at approximately 100 volts per mil of dry film thickness. Thus, a 100 mil system would be tested at 10,000 volts dc. Pinholes are detected when the current reaches the conductive layer (electrical ground site) via the pinhole, and completes the electrical circuit to which the voltage device is grounded at which time an alarm is activated. Suitable test equipment includes holiday detectors from Tinker & Rasor (San Gabriel, Calif.). When pinholes are detected, they are marked for subsequent repair.

The topcoat layer is preferably a polymer layer that meets the requirements of the National Sanitation Foundation (NSF)/American National Standards Institute (ANSI) standards for contact with potable water, also known as NSF Standard 61. In one embodiment, the topcoat layer comprises a polyamide epoxy coating. An example of a topcoat polymer is the Dudick Protecto-Coat 310 NES polymer, provided by the Assignee of record and which is certified for use in water temperatures up to 100° F. The topcoat may be applied to a thickness of about 4-7 mils DFT, although the amount of topcoat is not particularly limited. An exemplary method of applying the topcoat is airless spraying. Optionally, a second topcoat may also be applied.

In the course of performing the method of the present invention, the concrete substrate should optimally be between about 50° F. and about 110° F. Additionally, the relative humidity during application of the layers should optimally not exceed 90 percent and the temperature of the substrate should optimally be at least about 5° F. above the dew point.

To demonstrate the effectiveness of the present invention, the method of coating a concrete structure was utilized as follows. The following examples should not be viewed as limiting the scope of the invention. The claims will serve to define the inventions.

Concrete water intake tanks that are part of the potable water system for the city of Chicago were coated with a lining system according to the present invention. The tanks were emptied and the surfaces were inspected for laitance, that is, fine particles on the surface of the concrete. Surface texture was similar to 40-60 grit sandpaper or the visual standard from the International Concrete Repair Institute, CSP comparison sample # 3 with exposed pea gravel. A polymer primer coat was applied at a rate of 1-4 mils DFT. The primer was a bisphenol A epoxy polymer catalyzed with an amine hardener. A conductive layer was then applied as described hereinabove.

A layer of base coat resin was then applied to the conductive layer. The basecoat resin was a silica-reinforced flexibilized epoxy polymer. The silica reinforcement was present at a rate of approximately 0.5 pounds per square foot of surface area of concrete substrate. The basecoat resin was applied by trowel at a thickness of about of about 1/16 inch or as needed to fill void and bridge cracks in the concrete. A fiberglass mat, saturated with the same basecoat resin mixture, was then applied to the uncured basecoat layer with edges of the mat overlapping by approximately one inch. The mat was then coated with another layer of basecoat resin, at a thickness of about 8-10 mils. The mat was then rolled with a ribbed roller to remove any visible wrinkles or air bubbles trapped under the fiberglass mat. The fiberglass-reinforced basecoat layer was then allowed to cure overnight.

The cured basecoat layer was then inspected for any imperfections such as air bubbles or blisters. Where necessary, such imperfections were removed and repaired, repeating the previous step for the section needing repair. The surface of the cured basecoat layer was sanded, and the overlapping seams of the fiberglass mat smoothed. The existing layers were then spark tested to insure that the system was pinhole free.

A topcoat layer was then applied to the base coat layer. More specifically, a polyamide epoxy Dudick Protecto-Coat 310 NSF layer was applied to a thickness of about 4-7 mils by airless spraying and allowed to cure for 24-48 hours.

The coated tanks were placed back into service for the city of Chicago and the coating layers were periodically inspected for their integrity over time. Over a time period of ten months, no degradation of the coating system or the underlying concrete was observed. This includes no noticeable discoloration, blistering, caulking, cracking or disbandment.

Based upon the foregoing disclosure, it should now be apparent that the method of coating a concrete structure in a potable water system will carry out the aspects set forth hereinabove. While the invention has been described with reference to concrete structures, it should also be appreciated that the method can be practiced to coat structures formed from other forms of cementitious materials as well as FRP's. It is, therefore, to be understood that any variations evident fall within the scope of the claimed invention and thus, the selection of specific component elements can be determined without departing from the spirit of the invention herein disclosed and described.

1. A method of coating potable water structures comprising:
applying a first resin to the interior surfaces of said structure and curing said resin to provide a primer layer;
applying a second resin, containing a conductive filler, to said primer layer and curing said resin to provide a conductive layer;
applying a first silica-reinforced resin to said conductive layer to provide an uncured basecoat precursor layer;
applying a reinforcing fabric to said uncured basecoat precursor layer;
applying a second silica-reinforced resin, which may be the same as or different from said first silica-reinforced resin, to said reinforcing fabric and curing said first and second silica-reinforced polymer resins to provide a basecoat layer; and
applying a polymer suitable for contact with potable water to said basecoat layer and curing said polymer to provide a topcoat layer;
wherein the method results in a coated surface that is suitable for contact with potable water and further wherein the coated surface is stable for a period of at least ten months after coating according to the method.

2. The method of claim 1, wherein said first resin applied to said interior surfaces comprises an epoxy resin.

3. The method of claim 1, wherein said epoxy resin is selected from the group consisting of bisphenol A, bisphenol F, a blend of bisphenol A with an ether selected from C₁₂-C₁₄ alkyl glycidyl ethers, neopentyl digylcidyl ether, cresyl glycidyl ether, 2-ethylhexyl glycidyl ether, or cyclohexane-dimethanol diglycidyl ether, epoxy novolac vinyl ester, bisphenol A-fumarate based polyester, or blends thereof.

4. The method of claim 1, wherein said second resin applied to said interior surfaces comprises an epoxy resin.

5. The method of claim 4, wherein said epoxy resin is selected from the group consisting of bisphenol A, bisphenol F, a blend of bisphenol A with an ether selected from C₁₂-C₁₄ alkyl glycidyl ethers, neopentyl digylcidyl ether, cresyl glycidyl ether, 2-ethylhexyl glycidyl ether, or cyclohexane-dimethanol diglycidyl ether, epoxy novolac vinyl ester, bisphenol A-fumarate based polyester, or blends thereof.

6. The method of claim 1, wherein said conductive filler is selected from the group consisting of graphite, conductive carbon black, carbon fiber, and coke.

7. The method of claim 1, wherein said first and second silica-reinforced resins are independently selected from the group consisting of bisphenol A resin, bisphenol F resin, vinyl ester resin, or polyester resin.

8. The method of claim 1, wherein at least one of the silica-reinforced resins further comprise a flexibilizing agent selected from the group consisting of epoxidized cashew nut oil, acrylate functional urethanes, liquid polysulfide resins polyamides, amido-amines, modified cycloaliphatics based on isophorone diamine (IPDA), meta-xylene diamine (MXDA), 1,3-Bis(aminomethyl) cyclohexane (1,3 BAC), methylene dicyclohexyl-amine (PACM), mannich base curing agents, aliphatic amines and their epoxy adducts.

9. The method of claim 1, wherein said reinforcing fabric comprises a fiberglass mat.

10. The method of claim 1, wherein said polymer suitable for contact with potable water comprises a polyamide epoxy polymer.

11. The method of claim 1, wherein the method further comprises the steps of applying a polymer suitable for contact with potable water to said topcoat layer and curing said polymer to provide an additional top coat layer.

12. The method of claim 11, wherein said polymer suitable for contact with potable water comprises a polyamide epoxy polymer.

13. The method of claim 1, wherein the method further comprises the step of spark testing said layers prior to said step of applying a polymer suitable for contact with potable water to the basecoat layer.

14. The method of claim 1, wherein said potable water structures are manufactured from materials selected from the group consisting of cementitious materials and fiber reinforced plastics.

15. A coated structure suitable for contact with potable water comprising:
a primer layer in contact with the interior surfaces of said structure;
a conductive layer in contact with said primer layer;
a silica-reinforced polymer resin basecoat layer in contact with said conductive layer, wherein said basecoat layer contains a reinforcing fabric; and
a polymer topcoat layer in contact with said basecoat layer, wherein said polymer topcoat layer is suitable for contact with potable water.

16. The coated structure of claim 15, wherein said primer layer is selected from the group consisting of bisphenol A, bisphenol F, a blend of bisphenol A with an ether selected from C₁₂-C₁₄ alkyl glycidyl ethers, neopentyl digylcidyl ether, cresyl glycidyl ether, 2-ethylhexyl glycidyl ether, or cyclohexane-dimethanol diglycidyl ether, epoxy novolac vinyl ester, bisphenol A-fumarate based polyester, or blends thereof.

17. The coated structure of claim 15, wherein said conductive layer comprises an epoxy resin and a filler selected from the group consisting of graphite, conductive carbon black, carbon fiber, and coke.

18. The coated structure of claim 17, wherein said epoxy resin is selected from the group consisting of bisphenol A, bisphenol F, a blend of bisphenol A with an ether selected from C₁₂-C₁₄ alkyl glycidyl ethers, neopentyl digylcidyl ether, cresyl glycidyl ether, 2-ethylhexyl glycidyl ether, or cyclohexane-dimethanol diglycidyl ether, epoxy novolac vinyl ester, bisphenol A-fumarate based polyester, or blends thereof.

19. The coated structure of claim 15, wherein said silica-reinforced polymer resin is selected from the group consisting of bisphenol A resin, bisphenol F resin, vinyl ester resin, or polyester resin.

20. The coated structure of claim 15, wherein said silica-reinforced resin further comprises a flexibilizing agent selected from the group consisting of epoxidized cashew nut oil, acrylate functional urethanes, liquid polysulfide resins polyamides, amido-amines, modified cycloaliphatics based on isophorone diamine (IPDA), meta-xylene diamine (MXDA), 1,3-Bis(aminomethyl) cyclohexane (1,3 BAC), methylene dicyclohexyl-amine (PACM), mannich base curing agents, aliphatic amines and their epoxy adducts.

21. The coated structure of claim 15, wherein said reinforcing fabric comprises a fiberglass mat.

22. The coated structure of claim 15, wherein said polymer topcoat layer suitable for contact with potable water comprises a polyamide epoxy polymer.

23. The coated structure of claim 15, wherein the structure further comprises an additional topcoat layer that is suitable for contact with potable water.

24. The coated structure of claim 15, wherein one or more of said layers are cured by using a hardener selected from the group consisting of polyamides, amido-amines, modified cycloaliphatics based on isophorone diamine (IPDA), meta-xylene diamine (MXDA), 1,3-Bis(aminomethyl) cyclohexane (1,3 BAC), methylene dicyclohexyl-amine (PACM), mannich base curing agents, aliphatic amines and their epoxy adducts.

25. The coated structure of claim 15, wherein said coated structure is essentially free from noticeable cracking, blistering, or discoloration after ten months of exposure to potable water.

26. The coated structure of claim 15, wherein said coated structures are manufactured from materials selected from the group consisting of cementitious materials and fiber reinforced plastics.
